(19) United States
(12) Patent Application Publication
(10) Pub. No.: US 2014/0345097 A1
(43) Pub. Date: Nov. 27, 2014

(54) RATCHETING TIE-DOWN WITH STRAP QUICK RELEASE FEATURE

(71) Applicant: JS Products, Inc., Las Vegas, NV (US)

(72) Inventor: Jared Hanlon, Las Vegas, NV (US)

(21) Appl. No.: 13/902,093

(22) Filed: May 24, 2013

(51) Int. Cl. B60P 7/08

(52) U.S. Cl. CPC B60P 7/083
USPC 24/69 ST

(57) ABSTRACT

A ratcheting tie-down mechanism has a strap quick-release feature. The mechanism has a pair of spaced reel pins about which a load strap may be wound by a ratcheting mechanism which is actuated by an actuating arm. One or both of the reel pins may be disconnected from the mechanism, such as by pulling it out of a gap in the mechanism in which the wound strap is located, whereby the strap may be easily disconnected from the mechanism.

### FIELD OF THE INVENTION

The present invention relates to ratcheting tie-down mechanisms.

### BACKGROUND OF THE INVENTION

Ratcheting tie-down mechanisms are commonly used to tension or tighten load restraining straps. A variety of configurations of such ratcheting tie-down mechanisms are known. For example, U.S. Pat. No. 6,95,848 to Jackson discloses a ratcheting tie-down mechanism which includes a clip with a guide hook having a receiving slot for the strap, which slot maintains the strap in alignment with a guide slot of the mechanism. U.S Patent Application Publication No. 2009/0283729 discloses a ratchet mechanism with an extendable handle for increasing the mechanical advantage of the lever.

Regardless of their specific configuration, a common feature of these ratcheting tie-down mechanisms is that an arm is used to rotate one or more reels, whereby the strap is wound around the one or more reels, tightening the strap. In general, use of these ratcheting tie-down mechanisms requires that an end of the strap be fed into a slot in the reel or through a slot between two portions of the reel so that the strap can be wound upon itself. Unfortunately, once the strap has been wound upon itself many times it becomes difficult to disconnect or release the strap from the mechanism.

U.S. Patent Application Publication No. 2011/0271500 discloses a ratchet mechanism having a detent on a handle and a frame, whereby ratchets can slide when the detent on the handle is in the detent on the frame, thus allowing the strap to be reeled out. However, this configuration still requires that the user move the handle into a specific position to reel out the strap and still requires that the user completely unwind the strap and remove it from the reel slot in order to disconnect it from the ratcheting tie-down mechanism.

### SUMMARY OF THE INVENTION

One aspect of the invention comprises a ratcheting tie-down mechanism with a strap quick release feature. In one embodiment the ratcheting tie-down mechanism has a pair of spaced reel pins about which a load strap may be wound, such as via operation of a ratcheting mechanism which is actuated by an actuating arm. One or both of the reel pins may be disconnected from the mechanism, such as by pulling the pin(s) out of a gap in the mechanism in which the wound strap is located, whereby the wound strap may be easily disconnected or released from the mechanism.

In one preferred embodiment, the ratcheting tie-down mechanism has first and second discs having one or more teeth on a periphery thereof, the first and second discs spaced apart from one another and defining a gap there between. The mechanism also comprises a first arm having a first catch mounted thereto, the first catch configured to selectively engage at least one tooth of each of the first and second discs. A second arm has a second catch mounted thereto, the second catch configured to selectively engage at least one tooth of each of the first and second discs. A first reel pin and a second reel pin are configured to span the gap between the first and second discs, the first and second reel pins configured to wind a strap which is mounted thereto.

The first arm is mounted for pivoting movement relative to the second arm, wherein movement of the first arm in a first direction effects rotation of the first and second discs and thus the first and second reel pins in a first direction by engagement of the first catch with the first and second discs, so as to wind a strap around the first and second reel pins, and wherein the second catch limits movement of the first and second discs in an opposing second direction. In addition, at least one of the first and/or second reel pins is movable between a first position in which the reel pin engages the first and second discs and a second position in which the reel pin does not span the gap between the first and second discs and no longer engages the strap, thus permitting the strap to be disconnected or released from the ratcheting tie-down mechanism.

Additional embodiments of the invention comprise methods of disconnecting a strap from a winding mechanism such as a ratcheting tie-down. In one such method, at least one of two reel pins are disconnected from a ratcheting tie-down mechanism to disengage the reel pin from a wound strap, thus permitting the strap to be disconnected or released from the mechanism.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a ratcheting tie-down mechanism in accordance with an embodiment of the invention; and

FIGS. 2A-G illustrate use of the ratcheting tie-down mechanism of the invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises a ratcheting tie-down mechanism having a strap quick release feature. The ratcheting tie-down mechanism is configured to reel or wind a load strap, such as to tension or tighten the strap. The ratcheting tie-down is configured to wind the strap around a pair of reel pins. At least one of the pins is removable or disconnectable, whereby a wound strap may be quickly released and removed from the mechanism.

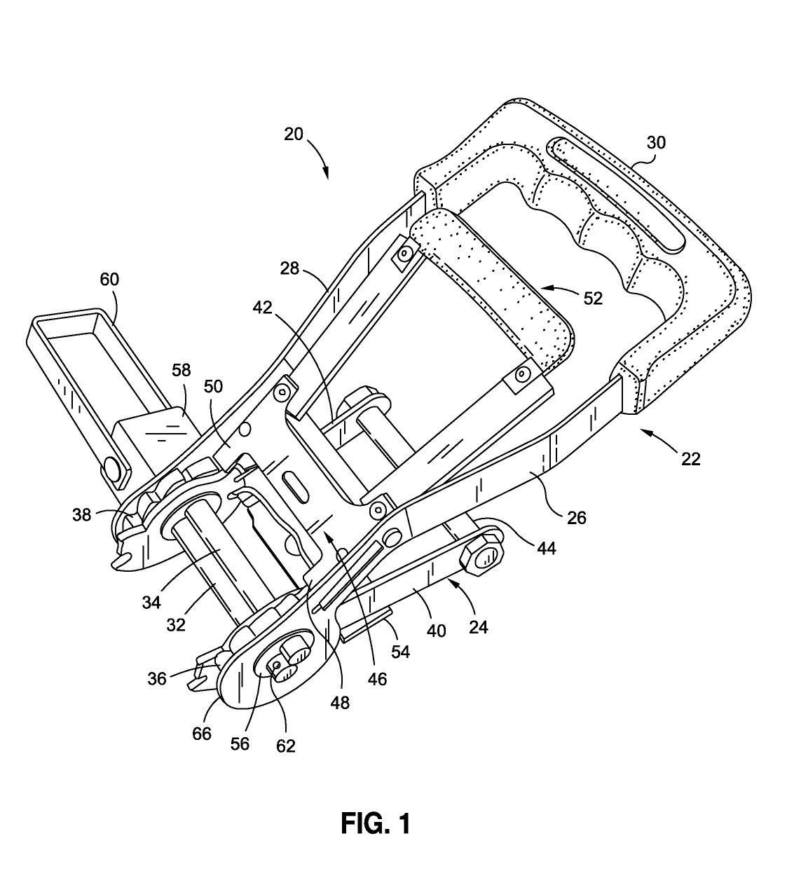

One embodiment of a ratcheting tie-down mechanism 20 in accordance with the invention will be described with reference to FIG. 1. As illustrated, the mechanism 20 has a first or actuating arm 22 and a second or mounting arm 24. The first arm 22 comprises first and second spaced mounts or legs 26,28 each having a first end and a second end. The first ends of the mounts 26,28 are connected by a handle 30. In the embodiment illustrated, the handle 30 includes a molded overlay grip. However, the handle 30 may have various shapes and configurations.

The second ends of the mounts 26,28 are spaced apart from one another a distance which permits a tie-down strap to be positioned between them. The second ends of the mounts 26,28 support a first reel pin 32 and a second reel pin 34 which are configured to wind a tie-down strap, as described below.

The first reel pin 32 and the second reel pin 34 are associated with a first toothed disc 36 and a second toothed disc 38. As described below, rotation of the first and second toothed discs 36,38 thus rotates the first and second reel pins 32,34.

The second arm 24 has a first leg 40 and a second leg 42. In one embodiment, a pin 44 extends between the first ends of the first and second legs 40,42. The pin 44 may be used, for example, to connect a first tie-down strap to the ratcheting tie-down mechanism 20. In one embodiment, the pin 44 may be removable, such as to permit a user to pass the pin through a looped end of a tie-down strap and then connect the pin 44 to the second arm 24, thereby fixing the tie-down strap to the ratcheting tie-down mechanism 20.

The first and second reel pins 32,34 extend between the second ends of the first and second legs 40,42 of the second arm 24. In a preferred embodiment, the first toothed disc 36 is located between the first mount 26 of the first arm 22 and the first leg 40 of the second arm 24. Likewise, the second toothed disc 38 is located between the second mount 28 of the first arm 22 and the second leg 42 of the second arm 24.

The ratcheting tie-down mechanism 20 includes a ratcheting mechanism. In one embodiment, a first catch 46 is configured to selectively engage the first and second toothed discs 36,38. As illustrated, the first catch 46 is slidably mounted on the first arm 22, such as within slots formed in the first and second mounts 26,28 of the first arm 22. The first catch 46 has first and second prongs 48,50. The first prong 48 extends downwardly for engagement with the first toothed disc 36 and the second prong 50 extends downwardly for engagement with the second toothed disc 38.

Preferably, means for biasing (not shown) are provided for biasing the first catch 46 into engagement with the first and second toothed discs 36,38. The means for biasing may comprise, for example, one or more springs.

In one embodiment, a grip 52 is mounted to the first catch 46. The grip 52 preferably extends from the first catch 46 in the opposite direction of the first and second prongs 48,50 and towards the handle 30 of the first arm 22. Once again, the grip 52 may have various configurations, including being a molded body which is shaped for easy gripping.

The ratcheting tie-down mechanism 20 also includes a second catch 54. The second catch 54 is preferably movably mounted to the second arm 24, such as within slots formed in the first and second legs 40,42 of the second arm 24. As illustrated, the second catch 54 spans the first and second legs 40,42 of the second arm 24 and is configured to also selectively engage the first and second toothed discs 36,38. Once again, means for biasing are preferably provided for biasing (not shown) the second catch 54 into engagement with the first and second toothed discs 36,38. The means for biasing may comprise, for example, one or more springs.

The first and second reel pins 32,34 are mounted to the first and second toothed discs 36,38 for rotation therewith and for rotation relative to the first arm 22 and the second arm 24 (for example, the first and second reel pins 32,34 may pass through one or more apertures in the first and second arms 22,24). Preferably, the first and second reel pins 32,34 are spaced from one another by a distance which is sufficiently great to permit a tie-down strap to pass between them (as described in more detail below).

In accordance with the invention, at least one of the first and/or second reel pins 32,34 is removable or disconnectable from the ratcheting tie-down mechanism 20, or at least removable from the space between the first and second toothed discs 36,38.

In one embodiment, the first reel pin 32 is fixedly mounted to the ratcheting tie-down mechanism 20. For example, the first reel pin 32 may pass through apertures in the first and second toothed discs 36,38 and be mounted to a pair of mounting discs 56 mounted at the exterior of the first and second mounts 26,28 of the first arm 22.

In such a configuration, the second reel pin 34 is preferably removable from the ratcheting tie-down mechanism 20. In one embodiment, the second reel pin 34 can be slid into and out of engagement with the first and second toothed discs 36,38 and the mounting discs 56. In one embodiment, the reel pins 32,34 rotate about an axis and the second reel pin 34 can be moved parallel to that axis of rotation.

In one embodiment, the second reel pin 34 comprises a shaft having a first end and a second end. To aid a user in inserting and removing the second reel pin 34, a head or mount 58 is located at one end of the second reel pin 34. A handle 60 preferably extends from the mount 58. The handle 60 may have various configurations. As illustrated, the handle 60 is generally “U”-shaped, having legs which are connected to the mount 58. Such a mounting may permit the handle 60 to rotate or pivot relative to the mount 58 so that the position thereof can be changed.

Of course, either or both reel pins 36,38 may be removable. In addition, the configuration of the pins 36,38 may vary. For example, the reel pins 36,38 may each have a first free end and a second end having an enlarged head. The head may be formed as a grip or handle or might directly have a handle connected thereto. In one embodiment, the free end of the removable pin might be threaded and engage threads on the mount 56 or other portion of the ratcheting tie-down mechanism 20 to ensure that the pin remains in place during use (and does not, for example, vibrate free).

In one or more embodiments, the removable pin may be tied or connected to the remainder of the ratcheting tie-down mechanism 20 to prevent it from being lost. For example, a wire, tie or the like may connect the head 58 of the second reel pin 34 to the first arm 22 or other portion of the ratcheting tie-down mechanism 20.

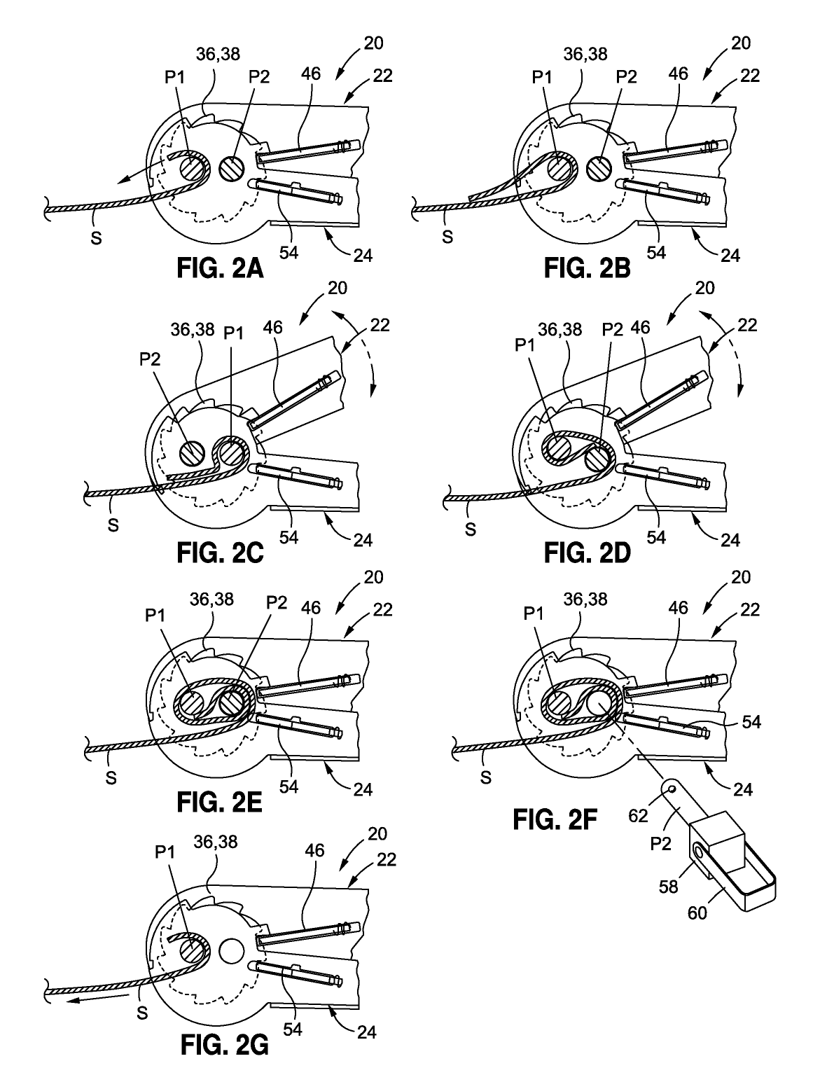

In one embodiment, the free end of each removable reel pin may include a spring-load ball 62 or the like (see FIGS. 1 and 2G). In such a configuration, at least a portion of the ball 62 may extend outwardly of the shaft of the pin so as to impede movement of the pin. However, when sufficient force is applied thereto, the ball 62 preferably moves inwardly, thus reducing the outer dimension of the pin and permitting its free movement. In this regard, the one or more reel pins are preferably removable or moveable without having to change the configuration of the tie-down mechanism 20, i.e. the one or more reel pins are designed to be moved or removed by the user. Preferably, the design permits the user to move or remove the one or more reel pins without tools, i.e. the one or more reel pins are designed to be readily removable under just the force of a user pulling the pins away from their mounting position.

In one embodiment either or both of the reel pins 36,38 may have a body or shaft which is cylindrical in shape. However, the shaft of either or both of the reel pins 36,38 may have other shapes, such as semi-circular or the like, such as illustrated in U.S. Patent Application Publication No. 2010/0205790 which is incorporated herein in its entirety.

Additional details of the ratcheting tie-down mechanism 20 will be appreciated from a description of a method of use thereof and FIGS. 2A-2G.

The ratcheting tie-down mechanism 20 is particularly suited to tightening a tie-down strap by reeling or winding a free end of the strap. Such straps are well known and may comprise woven nylon or other materials.

Referring to FIG. 2A, a free end of the strap S is inserted into the gap or opening between the first and second toothed discs 36,38 and is threaded between the first reel pin P1 and the second reel pin P2. Referring to FIG. 2B, the free end of the strap S is pulled back towards the main body of the strap so that the free end overlaps the remainder of the strap S.

Referring to FIG. 2C, the user actuates the first handle 22 by raising it upwardly, thus moving the first handle 22 counter-clockwise in this figure. As the user move the first handle 22 counter-clockwise, the first catch 46 engages teeth on the first and second toothed discs 36,38, thus causing the toothed discs 36,38 to also rotate counter-clockwise.

Once the user rotates the first handle 22 counter-clockwise approximately 90 degrees, the user rotates the first handle 22 back clock-wise to the starting position. At this time, the first catch 46 rides over smooth back faces of the teeth of the first and second toothed discs 36,38 (such that the movement of the first handle 22 does not result in movement of the toothed discs 36,38). The position of the first and second toothed discs 36,38, and thus the strap S, is maintained by engagement of the second catch 54 with the first and second toothed discs 36,38.

Referring to FIGS. 2D and 2E, repeated movement of the first arm 22 in this fashion results in the strap S being wound around the first and second reel pins P1 and P2. Notably, as the strap S winds on itself, friction maintains the strap S prevents the strap S from loosening or unwinding around the reel pins P1,P2.

The user may continue to wind the strap S until a desired tension is applied to the strap S or a desired length of the strap S has been wound onto the ratcheting tie-down mechanism 20, such as is required to secure a load. The tension on the strap S is maintained because the first and second toothed discs 36,38 are locked against an unwinding rotation by the second catch 54.

Most importantly, when the user is done using the ratcheting tie-down mechanism 20 of the invention, the user can easily untension the strap S and remove the strap S. First, the user can untension the strap S by pulling upwardly on the grip 52 of the first catch 46, thus moving the first catch 46 out of engagement with the first and second toothed discs 36,38. The user can then rotate the first arm 22 counter-clockwise until protruding sections 66 of the mounts 26,28 thereof press upon the second catch 54, forcing it rearwardly out of engagement with the first and second toothed discs 36,38. At that point, the first and second toothed discs 36,38 are free to unwind under the tension of the strap S.

At that time, however, the strap S will still be wound around the first and second reel pins P1 and P2, albeit without a high level of tension. In accordance with the present invention, the user can release the strap S by simply removing one of the reel pins from the ratcheting tie-down mechanism 20.

As illustrated in FIG. 2F, the user may remove the second reel pin P2 by pulling it outwardly from the ratcheting tie-down mechanism 20. Once the pin is removed, the strap S is no longer wound tightly around the first and second reel pins P1 and P2. As illustrated in FIG. 2G, this permits a user to simply pull on the strap S to disengage it from the ratcheting tie-down mechanism.

This feature has significant advantages over the prior art. In particular, in the prior art where a strap is wound around reels of the device, the user would be required to feed some strap S backwardly towards the ratcheting tie-down mechanism and feed that slack around the reel pins until the free end of the strap S was not frictionally bound. The user would then be required to slowly unwind the strap S from the free end thereof outwardly around the reel pins until the strap S was free from the ratcheting tie-down mechanism. This can be a tedious and time-consuming process.

On the other hand, in accordance with the present invention, the user simply removes one or both reel pins, thus directly loosening the strap S and permitting the strap S to be pulled free of the ratcheting-tie down mechanism 20.

It will be appreciated that while one or both reel pins may be completely removed from the ratcheting tie-down mechanism, the one or more reel pins may also simply be removed from inside of the wound strap and/or the gap or opening between the sides of the mechanism (such as between the first and second legs 40,42 of the second arm 24 in the mechanism illustrated in FIG. 1). For example, the second reel pin 34 might be configured so that the free end thereof can be pulled from the position illustrated in FIG. 1 to a point where the free end is located adjacent the second leg 42 of the second arm 24 or within the second leg 42 of the second arm 24, within the second toothed disc 38 or within the second mount 28 of the first arm 22 (i.e. wherein the free end of the second reel pin 34 is moved to a point external to the wound strap whereby the strap no longer engages the second reel pin 34 and thus is not impeded from being removed from the mechanism).

As indicated, it is also possible for both reel pins 32,34 to be removable or disconnectable. In one embodiment, the reel pins 32,34 may be configured to be moved/removed in the same direction or from opposing sides of the mechanism 20. It is also possible for the first and second reel pins 32,34 to be joined or connected so that they can be removed at the same time.

Of course, in order to re-use the ratcheting tie-down mechanism 20 after a strap S has been removed, the user preferably re-connects the one or more removable reel pins so that the strap can again be thread between the reel pins.

It will be appreciated that the principles of the invention may be applied to ratcheting tie-down mechanisms which have other configurations. As indicated above, other configurations of ratcheting tie-downs other than that specifically illustrated in FIG. 1 are now known and may later be developed (such mechanisms may include other types of ratcheting mechanisms, releases, extendable handles or other features). For example, the principles of the invention could be applied to the devices which are illustrated in U.S. Pat. Nos. 6,195,848 and, 7,950,629, and U.S. Patent Application Publication Nos. 2012/0073097, 2008/0178439, 2010/0064489, 2010/0071174, 2010/0199473, 2010/0199474, 2010/0205790 and 2011/0271500, all of which are incorporated in their entirety herein.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A strap tightening mechanism comprising:
first and second discs having one or more teeth on a periphery thereof, the first and second discs spaced apart from one another and defining a gap there between;
a first arm having a first catch mounted thereto, the first catch configured to selectively engage at least one tooth of each of the first and second discs;
a second arm having a second catch mounted thereto, the second catch configured to selectively engage at least one tooth of each of the first and second discs;
a first reel pin and a second reel pin for spanning said gap between said first and second discs, said first and second reel pins configured to wind a strap which is mounted thereto;
said first arm mounted for pivoting movement relative to said second arm, wherein movement of said first arm in a first direction effects rotation of said first and second discs and said first and second reel pins in a first direction by engagement of said first catch with said first and second discs to wind a strap around said first and second reel pins and wherein said second catch limits movement of said first and second discs in an opposing second direction; and
at least one of said first and second reel pins movable between a first position in which said reel pin engages said first and second discs and a second position in which said reel pin is removed from said first and second discs and does not span said gap between said first and second discs, permitting said strap to be released from said mechanism.

2. The strap tightening mechanism in accordance with claim 1 wherein said first disc is located between a first mount of said first arm and a first leg of said second arm and said second disc is located between a second mount of said first arm and a second leg of said second arm and wherein during winding of a strap said first and second pins extend through said first and second mounts of said first arm, said first and second legs of said second arm and said first and second discs.

3. The strap tightening mechanism in accordance with claim 1 wherein said first pin comprises a shaft having a first end and a second end and a head located at said first end.

4. The strap tightening mechanism in accordance with claim 3 further comprising a handle connected to said head.

5. The strap tightening mechanism in accordance with claim 4 wherein said handle is generally U shaped and is pivotally mounted to said head.

6. The strap tightening mechanism in accordance with claim 3 further comprising a ball stop located at said second end of said shaft.

7. A method of disconnecting a strap from a ratcheting tie-down mechanism comprising:
passing a free end of a strap between first and second reel pins of said ratcheting tie-down mechanism;
actuating an arm of said ratcheting tie-down mechanism;
rotating said first and second reel pins about an axis in response to said actuation of said arm;
winding said strap around said first and second reel pins; and
disconnecting at least one of said first and second reel pins from said ratcheting tie-down mechanism; and
disconnecting said strap from said ratcheting tie-down mechanism.

8. The method in accordance with claim 7 wherein said step of disconnecting at least one of said reel pins comprises moving a body of at least one reel pin out of engagement with said strap.

9. The method in accordance with claim 7 wherein said step of disconnecting at least one of said reel pins comprises moving a body of at least one reel pin out of a strap winding space.

10. The method in accordance with claim 9 wherein said strap winding space is located between first and second toothed ratcheting discs of said mechanism.

11. The method in accordance with claim 7 wherein said step of disconnecting at least one of said reel pins comprises gripping a handle of said reel pin and pulling on said handle.
